(19) United States
(12) Patent Application Publication
(10) Pub. No.: US 2006/0251242 A1
(43) Pub. Date: Nov. 9, 2006

(54) Method and control circuit for generating a supply direct voltage for an analogue telephone

(76) Inventors: Alberto Canella, Villach (AT); Gerhard Noessing, Villach (AT)

Correspondence Address: JENKINS, WILSON, TAYLOR & HUNT, P. A., 3100 TOWER BLVD, SUITE 1200, DURHAM, NC, 27707, US

(21) Appl. No.: 11/417,587

(22) Filed: May 4, 2006

(30) Foreign Application Priority Data
May 4, 2005 (DE) 102005020896.7

(51) Int. Cl. H04M 1/00

(52) U.S. Cl. 379/399.01

(57) ABSTRACT

A control circuit for generating a supply direct voltage for an analogue telephone comprises an SLIC circuit and a CODEC circuit. An analogue telephone is connectable to the SLIC circuit via a two-wire telephone line and the SLIC circuit detects a loop direct current flowing through the two-wire telephone line when connected to the SCLIC circuit. The CODEC circuit comprises a constant voltage source for generating a constant voltage and a subtractor for generating a differential voltage by subtracting a voltage proportional to the loop direct current from the constant voltage. The differential voltage is amplified with a constant gain factor for generating the supply direct voltage.

### BACKGROUND OF THE INVENTION

The invention relates to a control circuit and to a method for generating a supply direct voltage for an analogue telephone.

A conventional analogue telephone is connected to a local exchange or to a branch exchange via a two-wire twisted copper line L_{A}, L_{B} (line a, line b). The analogue telephone does not have its own direct voltage supply but is supplied with a direct voltage from the local exchange or from the branch exchange. By lifting off the receiver (going off-hook), a contact closes (a so-called hook switch) and a direct current flows which is detected in the exchange, for example by means of a relay. This signals the call intent of the telephone subscriber going off-hook to the switching device.

By replacing the receiver after the call, the hook switch opens and interrupts the direct current loop. The telephone voice signals are superimposed on the direct current.

In most cases, the transmit circuit (speaker) is separated from the receive circuit (receiver) by means of so-called hybrid network. The exchanges of the telephone network operate in accordance with the principle of circuit switching. In this arrangement, the user channels are transparently switched through in the exchanges (so-called network nodes). The subscriber controls the connection set-up by dialing information.

In contrast to the ISDN telephone network, the so-called POTS (Plain Old Telephone Service) telephone network is not digitally constructed. Each analogue telephone is connected to a line card via telephone subscriber lines. The line card has a circuit for generating a DC direct voltage and a supply current for remote analogue telephones. In this arrangement, a predetermined open-circuit voltage of, for example, 48 volts is generated. By means of a predetermined output resistance which depends on the load resistance of the analogue telephone and the resistance of the telephone line, a supply current is generated within a predetermined current range, the current range typically lying within a range of 20-30 mA. In addition, current limiting is provided which prevents the current from exceeding 60 mA. In the off-hook mode of the telephone receiver, that is to say during the telephone call, the supply current should be within the desired predetermined current range for predetermined load resistances and telephone line lengths.

FIG. 1 shows a conventional control circuit for generating a supply direct voltage for an analogue telephone. The analogue telephone has a certain load resistance R_{Tel} which is typically between 100 and 430 ohms. The analogue telephone is connected to two telephone connections (tip, ring) of a SLIC circuit via twisted two-wire telephone lines and external protective resistors. The SLIC circuit is an integrated circuit which is capable of measuring or detecting the loop direct current flowing via the telephone line. For this purpose, the SLIC circuit has a controlled current source which outputs the loop direct current (I_{LOOP}) with a certain scaling factor (SF) mirrored at an output of the SLIC circuit. The mirrored loop direct current flows to earth via a resistor R_{SENSE} and generates a direct voltage V_{SENSE} which is proportional to the loop direct current I_{LOOP}. The voltage V_{SENSE} is present at an input of a CODEC circuit. At the input of the CODEC circuit, the analogue AC telephone signal is additionally coupled out via a coupling capacitor C_{COUPLING}. The resistor R_{SENSE} typically has a resistance value of 500 ohms. The external protective resistors by means of which the telephone is connected to the SLIC circuit typically have in each case a resistance of 50 ohms. An analogue prefilter provided in the CODEC circuit is used as anti aliasing filter (AAF) and precedes an analogue/digital converter ADC. The analogue/digital converter samples the applied analogue signal with a relatively high sampling frequency of, for example, 4 MHz. The sampled digital signal is decimated to a lower sampling frequency by a downstream digital decimation filter. The decimation filter is followed by a first-order digital low-pass filter, the cut-off frequency of which is 0.3 Hz. The low-pass-filtered digital signal is processed by a digital signal processor DSP to produce a certain flat current/voltage characteristic at the connected analogue telephone as is shown in FIG. 2.

At the output end, the digital signal processor DSP is followed by a further low-pass filter having a cut-off frequency of, for example 8 Hz. The low-pass-filtered filter is supplied to an interpolation filter which interpolates the signal and outputs it to a digital/analogue converter DAC. The digital/analogue converter converts the applied digital signal with a sampling frequency of, for example, 4 MHz into an analogue signal. A resistor R_{F} integrated in the CODEC, together with an external capacitor C_{F}, form a first-order analogue low-pass filter. The digital/analogue converter DAC is, for example, a single-bit sigma/delta analogue converter with noise shaping function. The analogue low-pass filter is followed by a post low-pass filter having a cut-off frequency of, for example, 100 KHz. The direct voltage delivered by the CODEC circuit is amplified with a certain signal gain factor by a signal amplifier V within the SLIC circuit and conducted to the two tip, ring connections of the SLIC circuit.

The conventional circuit arrangement shown in FIG. 1 leads to the current/voltage characteristic at the analogue telephone as shown in FIG. 2.

Point P1 on the characteristic represents a short-circuit case, that is to say the sum of the telephone load resistance with the line resistance is 0 ohms.

In the example specified, the sum of the telephone load resistance R_{Tel} and the line resistance R_{LINE} at point P2 on the characteristic is 1520 ohms, the load resistance R_{Tel} of the telephone being typically between 100 and 430 ohms.

At point 3 on the characteristic, the sum of the telephone load resistance and the line resistance is, for example, 2300 ohms. At point P1, the loop direct current flowing through the analogue telephone is 26.5 mA with a scaling factor SF of 50 and a resistance R_{SENSE} of 500 ohms, and is thus still within the permissible range between 20 and 30 mA. With a relatively long telephone line having a line resistance of about 1 kΩ, the loop direct current is about 23 mA at point P2 on the characteristic and is thus also still within the permissible current range. It is only above a total resistance of 2300 ohms that the loop direct current drops to a current value I3 of about 20 mA which only allows emergency operation of the analogue telephone.

The circuit arrangement shown in FIG. 1 thus has the flat current/voltage characteristic shown in FIG. 2. The circuit arrangement shown in FIG. 1 is thus also suitable for telephone lines which are relatively long and have a relatively high line resistance R_{LINE}. An adequate supply of the analogue telephone is thus ensured even for relatively long telephone lines having a line resistance of about 2 kΩ.
However, the disadvantage of the circuit arrangement according to the prior art as shown in FIG. 1 consists in that the circuit expenditure for implementing it is very high. The circuit arrangement comprises a complex analogue/digital converter and a complex digital/analogue converter. In addition, various digital filters are provided within the CODEC circuit, and a digital signal processor DSP. The reason for this is mainly that a very low cut-off frequency of f_{G}=0.3 Hz can be implemented efficiently only by means of a digital low-pass filter.

The necessity for a flat current/voltage characteristic as shown in FIG. 2 does not exist in all applications, that is to say in many cases, the telephone line for connecting the analogue telephone to the SLIC circuit is relatively short and has a low line resistance R_{LINE}. In these applications, the circuit expenditure as produced by the circuit arrangement in FIG. 1 is not justified.

### BRIEF SUMMARY OF THE INVENTION

According to the invention, a control circuit for generating a supply direct voltage for an analogue telephone comprises a SLIC circuit to which the analogue telephone is connected via a two-wire telephone line, wherein the SLIC circuit detecting a loop direct current flowing via the telephone line, a CODEC circuit which has a constant voltage source for generating a constant voltage, and a subtractor which subtracts a voltage proportional to the loop direct current for generating a differential voltage, the differential voltage being amplified with a constant gain factor (Gain) for generating the supply direct voltage.

In a preferred embodiment of the inventive control circuit, the SLIC circuit mirrors the loop direct current for generating a mirror current which, scaled with a mirror scaling factor, flows via a resistor provided between the SLIC circuit and the CODEC circuit for generating the voltage proportional to the loop direct current.

The CODEC circuit may have a signal amplifier which amplifies the differential voltage with a CODEC signal gain factor.

The CODEC circuit may have an analogue low-pass filter for filtering the differential voltage signal delivered by the signal amplifier.

The SLIC circuit may also have a signal amplifier which amplifies the filtered differential voltage signal V_{DIFF} delivered by the low-pass filter with a SLIC signal gain factor G_{SLIC} for generating the supply direct voltage.

The constant gain factor may be formed by the product of the CODEC signal gain factor and the SLIC signal gain factor, the constant voltage generated by the voltage source of the CODEC circuit can be inverted in dependence on a control signal for generating a signal, the resistor provided between the SLIC circuit and the CODEC circuit may be exchangeable, the resistor is applied to an input of the CODEC circuit, an AC telephone signal may be coupled out by means of a coupling capacitor at the input of the CODEC circuit, the analogue low-pass filter may be a first-order low-pass filter, the analogue low-pass filter may have a cut-off frequency of about 8 Hz, and/or the analogue low-pass filter may be comprised of a resistor integrated in the CODEC circuit and a capacitor provided between the CODEC circuit and the SLIC circuit.

The analogue telephone may have a certain load resistance and/or may be connected to a first connection of the SLIC circuit via a first telephone wire and via a first protective resistor and to a second connection of the SLIC circuit via a second telephone wire and via a second protective resistor.

The load resistance of an analogue telephone may be between 100 and 430 ohms and the scaling factor maybe 50.

The resistor provided between the SLIC circuit and the CODEC circuit may have a resistance value of 500 ohms and the constant voltage source may generate a constant voltage of 0.3 volts.

The gain factor may be 160 so that the open-circuit voltage present at the two connections of the SLIC circuit is 48 volts.

The CODEC signal gain factor of the signal amplifier provided in the CODEC circuit may be 4 and the SLIC signal gain factor of the signal amplifier provided in the SLIC circuit may be 40.

The two protective resistors in each case may have a resistance value of 50 ohms.

The constant voltage source may be formed by a band-gap reference voltage source.

According to the invention, a method for generating a controlled supply direct voltage for an analogue telephone comprises the steps of:
detecting a direct current flowing via a two-wire telephone line to the analogue telephone,
mirroring the loop direct current for generating a mirror current which flows via a resistor for generating a voltage V_{SENSE} proportional to the loop direct current, subtracting the generated proportional voltage from a constant voltage for generating a differential voltage, and
amplifying the differential voltage for generating the supply direct voltage for the analogue telephone.

The differential voltage may be low-pass filtered.

In the text which follows, preferred embodiments of the control circuit according to the invention and of the method according to the invention for generating a supply direct voltage for an analogue telephone are described with reference to the attached figures in order to explain features essential to the invention.

### BRIEF DESCRIPTION OF THE SEVERAL VIEWS OF THE DRAWINGS

FIG. 1, as discussed above, is a conventional circuit arrangement for generating a supply direct voltage for an analogue telephone.

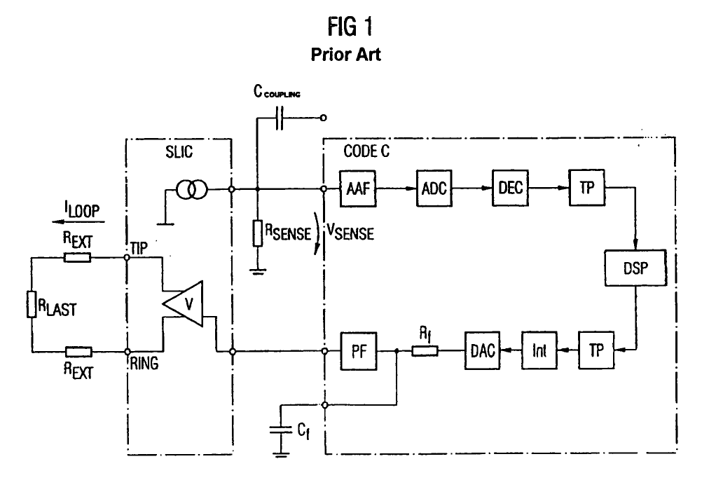

FIG. 2, as discussed above, is a current/voltage characteristic of the circuit arrangement of FIG. 1.

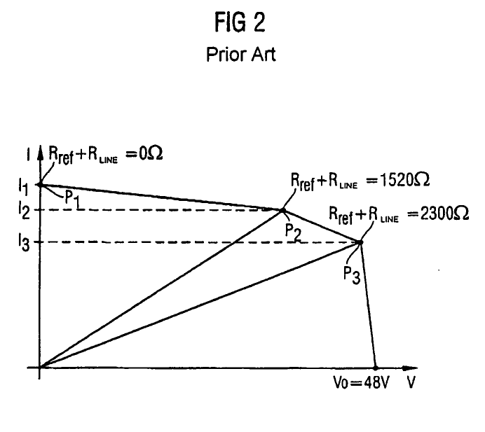

FIG. 3 is an exemplary embodiment of an inventive control circuit for supplying an analogue telephone with a supply direct voltage.

FIG. 4 is a current/voltage characteristic of the inventive control circuit of FIG. 3.

### DETAILED DESCRIPTION OF THE INVENTION

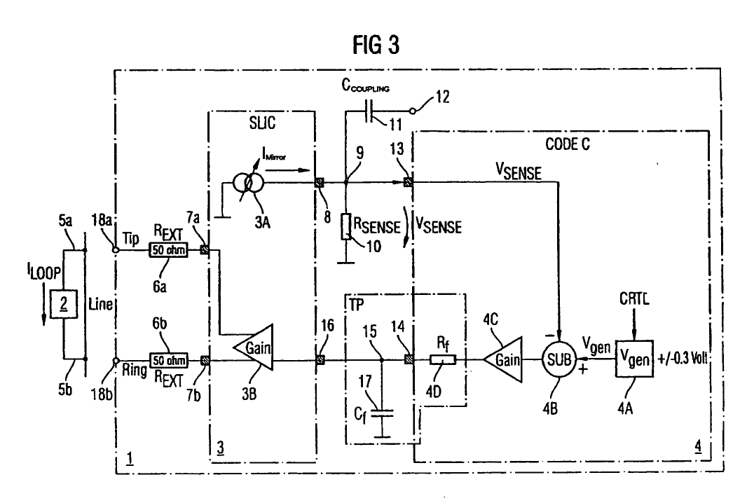

As can be seen from FIG. 3, the control circuit 1 according to the invention for generating a supply direct voltage for an analogue telephone 2 contains a SLIC circuit 3 and a CODEC circuit 4. The analogue telephone 2 is connected to two connections 7a, 7b of the SLIC circuit 3 via a two-wire telephone line 5a, 5b and two protective resistors 6a, 6b. The SLIC circuit 3 detects the loop direct current I_{LOOP}flowing via the two-wire telephone line 5. To this end, the SLIC circuit 3 mirrors the loop direct current for generating a mirror current I_{Mirror} which flows via an output 8 of the SLIC circuit 3 to a node 9 and from there to earth via a resistor 10. The earth is preferably generated as virtual earth by the CODEC circuit 4. The SLIC circuit 3 generates the mirror current I_{Mirror} which is scaled with a mirror scaling factor SF. As can be seen from FIG. 3, the SLIC circuit 3 contains a controlled current source 3a which is controlled in dependence on the detected loop direct current I_{LOOP}. In a preferred embodiment, the mirror scaling factor SF is 50, that is to say the mirrored power flow has an amplitude which is one fiftieth of the amplitude of the detected loop current I_{LOOP}. A coupling capacitor 11 via which an AC telephone signal is coupled out at an output 12 is connected to the node 9.

The CODEC circuit 4 has a signal input 13 which is connected to node 9. The mirrored current I_{Mirror} flowing off through the resistor 10 generates a voltage (V_{SENSE}) which is proportional to the loop direct current I_{LOOP} which flows through the analogue telephone 2. This proportional voltage V_{SENSE} is present at the high-resistance input 13 of the CODEC circuit 4. The CODEC circuit contains a constant voltage source 4a which generates a constant voltage V₁₀.

In a preferred embodiment, the generated constant voltage is 0.3 volts. In a particularly preferred embodiment, the constant voltage source 4A is formed by an internal band-gap reference voltage source of the CODEC circuit. The reference voltage source 4A can be preferably inverted in dependence on a control signal CTRL. Inverting the polarity of the constant voltage makes it possible to perform signaling. The CODEC circuit 4 also contains a subtractor 4B which subtracts the voltage V_{SENSE} present across the resistor 10 from the generated constant voltage V_{Gen} for generating a differential voltage V_{DIFF}.

The CODEC circuit 4 also contains a signal amplifier 4C which amplifies the generated differential voltage V_{DIFF} with a CODEC signal gain factor G_{CODEC}. The output of the signal amplifier 4C is connected to a resistor 4D which is also integrated in the CODEC circuit 4. The resistor 4D is connected to an output 14 of the CODEC circuit 4. This output 14 of the CODEC circuit 4 is connected to an input 16 of the SLIC circuit 3 via a node 15. In addition, the node 15 is connected to earth via a capacitor 17. The resistor 4D integrated in the CODEC circuit 4 and the external capacitor 17 together form an analogue first-order low-pass filter TP.

In a preferred embodiment, a differential connection exists between the CODEC circuit 4 and the SLIC circuit 3, the capacitor 17 being interconnected between the two differential lines.

The SLIC circuit 3 also contains a signal amplifier 3B which amplifies the filtered differential voltage signal output by the low-pass filter TP with a SLIC signal gain factor G_{SLIC} for generating a supply direct voltage for the analogue telephone 2. At the output end, the signal amplifier 3B of the SLIC circuit 3 is connected to the two telephone connections 7a, 7b for connecting the analogue telephone 2. The differential voltage output by the subtractor 4B of the CODEC circuit 4 is amplified with a constant gain factor for generating the supply direct voltage of the analogue telephone 2. The amplification is performed by the first signal amplifier 4D within the CODEC circuit and the second signal amplifier 3B within the SLIC circuit 3. The constant gain factor Gain is obtained from the product of the CODEC signal gain factor G_{CODEC} and the SLIC signal gain factor G_{SLIC} of the signal amplifier 3B.

As can be seen from FIG. 3, the SLIC circuit 3 and the CODEC circuit 4 are interconnected via the nodes 9, 15 to form a DC control circuit for generating a supply direct-current for the analogue telephone 2. The circuit expenditure for generating the supply direct voltage is minimal. Exchanging the external components which are not integrated in the SLIC circuit 3 and the CODEC circuit 4, that is to say exchanging the resistor 10 and the capacitor 17 makes it possible to adapt the circuit arrangement 1 shown in FIG. 3 to various applications.

The circuit arrangement 1 has a first connection 18a which can also be called tip connection, and a second connection 18b which is also called ring connection. At these two connections 18a, 18b, the two-wire telephone line 5 which is formed by the first telephone wire 5a and by a second telephone wire 5b is connected. The load present at connection 18 is formed by the resistance of the telephone line and by the resistance R_{Tel} of the analogue telephone 2:
R_{LAST}=R_{Tel}+R_{LINE}

The resistance R_{Tel} of the analogue telephone 2 is typically between 100 and 430 ohms.

The resistance R_{LINE} of the line 5 depends on the length of the telephone line. The circuit arrangement 1 according to the invention as shown in FIG. 3 is particularly suitable for applications in which the telephone lines 5 are relatively short and thus have a relatively low resistance. The circuit arrangement 1 according to the invention for generating the supply direct voltage for the analogue telephone 2 is mainly suitable for short telephone lines which have a length of less than half a kilometre.

The controlled current source 3A of the SLIC circuit 3 detects the loop direct current I_{LOOP} flowing through the analogue telephone 2 for generating a scaled, mirrored mirror current I_{Mirror},

$${I}_{Mirror} = \frac{{I}_{LOOP}}{SF}$$

where the scaling factor SF is preferably 50.

Across the resistor 10, a voltage V_{SENSE} proportional to the loop direct current I_{LOOP} is dropped:

$${V}_{SENSE} = {I}_{Spiegel} \cdot {R}_{10} = \frac{{I}_{LOOP}}{SF} \cdot {R}_{10}$$

A constant voltage V_{Gen} is subtracted by the integrated subtractor 4B of the CODEC circuit 4 from the voltage V_{SENSE} dropped:
V_{DIFF}=V_{Gen}−V_{SENSE}

This differential voltage V_{DIFF} is filtered by the low-pass filter TP and amplified with a constant gain factor Gain by the two signal amplifiers 4C, 3B.

The gain factor Gain is obtained from the product of a CODEC signal gain factor G_{CODEC} of the signal amplifier 4C and a SLIC signal gain factor G_{SLIC} of the signal amplifier 3B.
Gain=Gain_{SLIC}×Gain_{CODEC},
where the SLIC signal gain factor Gain_{SLIC} is preferably 40 and the CODEC signal gain factor Gain_{CODEC} is preferably 4.

In a preferred embodiment, the CODEC signal gain factor Gain_{CODEC} can be switched from 4 to 16/3=5.33 so that a SLIC circuit having a SLIC gain factor Gain_{SLIC} of 30 can be used without shifting the characteristic.

This results in a constant gain factor Gain of 160.

Thus, a DC direct voltage V_{DC} is present at connections 7a, 7b:

$$\begin{matrix}{V}_{DC} = Gain \cdot {V}_{DIFF} \\ = Gain \cdot ( {V}_{gen} - {V}_{SENSE} ) \\ = {Gain}_{SLIC} \cdot {Gain}_{CODEC} \cdot ( {V}_{gen} - \frac{{I}_{LOOP}}{SF} \cdot {R}_{10} )\end{matrix}$$

The supply direct voltage V_{TR} present between the tip connection 18 and the ring connection 18b is obtained from a constant open-circuit voltage V₀ which is reduced by a voltage value which is proportional to the loop direct current I_{LOOP} actually flowing:
V_{TR}=V₀−R₀×I_{LOOP},
the loop direct current I_{LOOP} depending on the load resistance R_{LOAD}:

$${I}_{LOOP} = \frac{{V}_{TR}}{R} = \frac{{V}_{TR}}{{R}_{LAST} + {R}_{0}} = \frac{{V}_{TR}}{{R}_{tel} + {R}_{LINE} + {R}_{0}}$$

where R₀ represents the output resistance of the circuit arrangement 1 at connections 18a, 18b.

The following applies for the output resistance R₀:

$${R}_{0} = \frac{1}{SF} \cdot {R}_{SENSE} \cdot Gain + 2 \cdot {R}_{EXT}$$

In a preferred embodiment, the output resistance R₀ of

$${R}_{0} = \frac{1}{50} \cdot 500 Ω \cdot 160 + 2 \cdot 50 Ω = 1700 Ω$$

is thus obtained. In the preferred embodiment with a gain factor of 160 and a generated constant voltage V_{Gen} of 0.3 volts, the open-circuit voltage V₀ is
V₀=0,3V×160=48V

Such an open-circuit voltage of 48 volts is required, for example, by the TELCORDIA GR 57 specification.

The short-circuit current at connections 18a, 18b, that is to say when the load resistance R_{LOAD} becomes zero, is

$${{I}_{LOOP}}_{max} = \frac{{V}_{0}}{{R}_{0}} = \frac{48 V}{1700 Ω} = 28 \text{,} 2 mA$$

An analogue telephone 2 which has the maximum resistance value of 430 ohms is supplied with the following direct current, neglecting the line resistance R_{LINE}:

$${I}_{LOOP} = \frac{{V}_{0}}{{R}_{tel} + {R}_{0}} = \frac{48 V}{430 Ω + 1700 Ω} = 22 \text{,} 6 mA$$

By inverting the voltage V_{Gen} delivered by the constant voltage source 4, a negative open-circuit voltage V₀ of −48 volts can be generated.

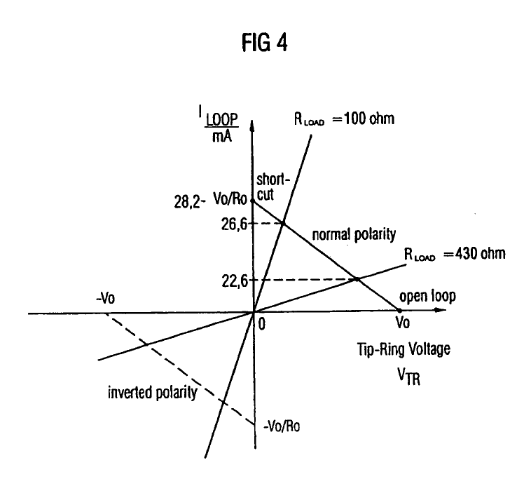

FIG. 4 shows the current/voltage characteristic of the circuit arrangement 1 according to the invention.

The short-circuit current is 28.2 mA and the open-circuit gain V₀ is 48 volts. Neglecting the resistance of the telephone line (R_{Tel=0}), the loop current is 26.6 mA with a telephone load resistance of 100 ohms and 23.6 mA with a maximum telephone load resistance of 430 ohms.

The loop current delivered by the circuit arrangement 1 according to the invention is thus within a permissible range of 20-30 mA for all analogue telephones.

The greater the output resistance R₀, the flatter the current/voltage characteristic shown in FIG. 4. This output resistance R₀ depends on the scaling factor SF, the resistance value R_{SENSE} of resistor 10 and the gain factor Gain as shown in equation 9.

In a preferred embodiment of the circuit arrangement 1 according to the invention, a current limiter which limits the current peaks of the loop current to 60 mA is provided in addition to the SLIC circuit 3.

The circuit arrangement 1 according to the invention as shown in FIG. 3 can be provided both in the exchange (central office) and on a line card of the subscriber. The circuit arrangement 1 according to the invention can be used, for example, in the ISDN turmoil adaptors or analogue telephone adaptors ATA. The current range can be scaled by suitably adjusting the resistance R₀. The voltage value of the open-circuit voltage V₀ can also be adapted by adjusting the signal gain factors Gain_{SLIC}, Gain_{CODEC} for various country specifications. The circuit arrangement according to the invention can be produced with a few passive components in a particularly inexpensive analogue technology which greatly limits the costs for the end product. The circuit expenditure of the control circuit according to the invention is low, using components already provided.

The stability of the control loop is ensured by the dominant pole of the low-pass filter which is formed by the resistor 4D and the capacitor 17. The analogue low-pass filter is preferably an analogue first-order low-pass filter with a cut-off frequency f_{g} of about 8 Hz. The cut-off frequency f_{g} can be easily adapted for various applications by exchanging the capacitor 17. The loop filter determines the convergence time or bandwidth in critical transition phases between the on-hook and off-hook modes.

Although modifications and changes may be suggested by those skilled in the art, it is the intention of the inventors to embody within the patent warranted hereon all changes and modifications as reasonably and properly come within the scope of their contribution to the art.

What is claimed is:

1. A control circuit for generating a supply direct voltage for an analogue telephone, comprising:
an SLIC circuit to which an analogue telephone is connectable via a two-wire telephone line; said SLIC circuit detecting a loop direct current flowing through said two-wire telephone line when said analogue telephone is connected to said SLIC circuit; and
a CODEC circuit comprising a constant voltage source for generating a constant voltage and comprising a subtractor for generating a differential voltage by subtracting a voltage proportional to said loop direct current from said constant voltage; said differential voltage being amplified with a constant gain factor for generating said supply direct voltage.

2. The control circuit of claim 1, wherein said SLIC circuit generates a mirror current by mirroring said loop direct current; said mirror current, scaled with a mirror scaling factor, flowing through a resistor provided between said SLIC circuit and said CODEC circuit for generating said voltage proportional to said loop direct current.

3. The control circuit of claim 1, wherein said CODEC circuit comprises a signal amplifier amplifying said differential voltage with a CODEC signal gain factor.

4. The control circuit of claim 3, wherein said CODEC circuit comprises an analogue low-pass filter for filtering said differential voltage signal delivered by said CODEC signal amplifier.

5. The control circuit of claim 4, wherein said SLIC circuit comprises a signal amplifier amplifying said differential voltage signal delivered by said low-pass filter with a SLIC signal gain factor for generating said supply direct voltage.

6. The control circuit of claim 5, wherein said constant gain factor is a product of said CODEC signal gain factor and said SLIC signal gain factor.

7. The control circuit of claim 1, wherein said constant voltage generated by said constant voltage source of said CODEC circuit is inverted dependent on a control signal for generating a signal.

8. The control circuit of claim 2, wherein said resistor provided between said SLIC circuit and said CODEC circuit is exchangeable.

9. The control circuit of claim 2, wherein the voltage across said resistor provided between said SLIC circuit and said CODEC circuit is present at an input of said CODEC circuit.

10. The control circuit of claim 9, comprising a capacitor for coupling out an AC telephone signal at said input of said CODEC circuit.

11. The control circuit of claim 4, wherein said analogue low-pass filter is a first-order low-pass filter.

12. The control circuit of claim 11, wherein said analogue low-pass filter has a cut-off frequency of 8 Hz.

13. The control circuit of claim 4, wherein said analogue low-pass filter is comprised of a resistor integrated in said CODEC circuit and a capacitor provided between said CODEC circuit and said SLIC circuit.

14. The control circuit of claim 1, wherein said analogue telephone comprises a predetermined load resistance.

15. The control circuit of claim 1, wherein said SLIC circuit comprises a first connection and a second connection; said analogue telephone being connectable to said first connection via a first telephone wire of said two-wire telephone line and a first protective resistor and to said second connection via a second telephone wire of said two-wire telephone line and a second protective resistor.

16. The control circuit of claim 14, wherein said load resistance of said analogue telephone is between 100 and 430 ohms.

17. the control circuit of claim 2, wherein said mirror scaling factor is 50.

18. The control circuit of claim 2, wherein said resistor provided between said SLIC circuit and said CODEC circuit has a resistance of 500 ohms.

19. The control circuit of claim 1, wherein said constant voltage source generates a constant voltage of 0.3 volts.

20. The control circuit of claim 15, wherein said gain factor is 160 so that the open-circuit voltage present at the two connections of the SLIC circuit is 48 volts.

21. The control circuit of claim 3, wherein said CODEC signal gain factor is four.

22. The control circuit of claim 5, wherein said SLIC signal gain factor is forty.

23. The control circuit of claim 15, wherein each of said two protective resistors have a resistance of 50 ohms.

24. The control circuit of claim 1, wherein said constant voltage source is a band-gap reference voltage source.

25. A method for generating a supply direct voltage for an analogue telephone, comprising the steps of:
detecting a loop direct current flowing through a two-wire telephone line to a analogue telephone;
mirroring said detected loop direct current for generating a mirror current flowing trough a resistor for generating a voltage proportional to said loop direct current;
generating a differential voltage by subtracting said voltage from a constant voltage; and
generating a supply direct voltage for said analogue telephone by amplifying said differential voltage.

26. The method according of claim 25, comprising low-pass filtering said differential voltage.
